(19) United States
(12) Patent Application Publication
(10) Pub. No.: US 2015/0289692 A1
(43) Pub. Date: Oct. 15, 2015

(54) INSULATED STEMMED DRINKING VESSEL AND METHOD OF PRODUCING THE SAME

(71) Applicant: Tervis Tumbler Company, North Venice, FL (US)

(72) Inventor: Ronald Wayne Bell, North Venice, FL (US)

(73) Assignee: Tervis Tumbler Company, North Venice, FL (US)

(21) Appl. No.: 14/248,756

(22) Filed: Apr. 9, 2014

(51) Int. Cl. A47G 19/22; B29C 65/02; B29C 65/16

(52) U.S. Cl. CPC A47G 19/2288; A47G 19/2227; A47G 19/2255; B29C 65/16; B29C 65/02; A47G 2200/20; B29L 2031/7132

(57) ABSTRACT

An insulated stemmed drinking vessel, e.g., a wine glass, and method of making the same is disclosed. The vessel includes a hollow bowl shaped member and a base member. The bowl shaped member has a sidewall having a thin upper rim. The bowl shaped member is disposed within a stemmed base member. The stemmed base member has an arcuate sidewall terminating in an upper edge which is welded to a peripheral portion of the hollow bowl shaped member substantially below the upper rim of the bowl shaped member to create a double walled insulating air space therebetween. A vibration dampening member may be disposed in that insulating air space. The dampening member may be decorative. The base member may be hollow and may also include a decorative member therein.

### FIELD OF THE INVENTION

This invention relates generally to drinking vessels and more particularly to insulated stemmed drinking vessels, e.g., wine glasses, and methods of producing the same.

### BACKGROUND OF THE INVENTION

Double walled insulated drinking vessels are commercially available from various vendors. There are also numerous U.S. Patents and published patent applications directed to doubled walled insulated drinking vessels, such as glasses, mugs, goblets, wine glasses and the like. See for example, U.S. Patents and published applications: U.S. Pat. No. 4,872,589 (Bolte); U.S. Pat. No. 5,090,213 (Glassman); U.S. Pat. No. 5,553,735 (Kimura); U.S. Pat. No. 5,839,599 (Lin); U.S. Pat. No. 6,050,443 (Tung et al.); U.S. Pat. No. 6,405,892 (Volan); U.S. Pat. No. 6,419,108 (Toida et al.); U.S. Pat. No. 6,921,179 (Ghanem); U.S. Pat. No. 7,306,113 (El-Saden et al.); D519,785 (Bodum); D526,848 (Bodum); D557,561 (Flowers et al.); 2004/0212120 (Giraud); 2005/0045643 (Ghanem); 2005/0173365 (McKnight); and 2005/0194340 (Huang).

While the insulated drinking vessels of the foregoing prior art may be generally suitable for their intended purposes, a need exists for drinking vessel in the form of a stemmed wine glass or goblet or other stemmed vessel which has a thin drinking lip preferred by consumers. The subject invention addresses that need by providing an insulated stemmed drinking vessel formed of plastic and which includes a thin, single walled upper lip or rim that is comfortable to drink from and a method of producing the same.

### SUMMARY OF THE INVENTION

In accordance with one aspect of this invention an insulated stemmed drinking vessel, e.g., a wine glass, is provided. The wine glass basically comprises a hollow bowl shaped member and a base member. The hollow bowl shaped member is molded of a plastic material and has a bottom wall and an arcuate side wall projecting upward from the bottom wall and terminating in a thin upper rim. The bowl shaped member is adapted to hold a liquid therein. The base member is molded of a plastic material and comprises a base portion, a stem portion and a holding portion. The base portion has a flat undersurface. The stem portion is elongated and extends upward from the base portion. The holding portion comprises an arcuate sidewall terminating in an upper edge. The arcuate side wall of the bowl shaped member includes an undercut ledge extending about the periphery of the arcuate side wall substantially below the thin upper rim. The bowl shaped member is disposed within the holding portion of the base member with the upper edge of the holding portion engaging the undercut ledge and is fixedly secured thereto along a seal line to create an insulating air space between the bowl shaped member and the base member, whereupon a substantial portion of the wine glass below the thin upper rim is double walled and insulated.

In accordance with one preferred embodiment of the insulated drinking vessel of this invention, the vessel includes a dampening member located within the insulating air space. The dampening member is arranged for dampening vibration imparted to the vessel and may be decorative to provide an aesthetically pleasing appearance for the vessel.

In accordance with another aspect of this invention a method of producing an insulated stemmed drinking vessel, e.g., a wine glass, is provided. The method basically entails providing a hollow bowl shaped member molded of a plastic material having a bottom wall and an arcuate side wall projecting upward from the bottom wall and terminating in a thin upper rim. A base member is also provided and is molded of a plastic material. The base member comprises a base portion, a stem portion and a holding portion. The base portion has a flat undersurface. The stem portion is elongated and extends upward from the base portion. The holding portion comprises an arcuate sidewall terminating in an upper edge. The bowl shaped member is disposed within the holding portion of the base member with the upper edge of the holding portion engaging a peripheral portion of the bowl shaped member below the upper rim along a seal line. The bowl shaped member is fixedly securing to the support member along the seal line to create an insulating air space between the bowl shaped member and the support member, whereupon a substantial portion of the wine glass below the thin upper rim is double walled and insulated.

### DESCRIPTION OF THE DRAWING

FIG. 1 is a is a front elevation view of one exemplary insulated stemmed wine glass constructed in accordance with this invention;

FIG. 2 is a vertical sectional view of the wine glass of FIG. 1 taken along line 2-2 thereof;

FIG. 3 is top plan view of the wine glass of FIG. 1 taken along line 3-3 thereof;

FIG. 4 is reduced isometric view of the wine glass shown in FIG. 1; and

FIG. 5 is an exploded isometric view of the components making up the wine glass shown in FIGS. 1-4.

### DETAILED DESCRIPTION OF THE PREFERRED EMBODIMENT

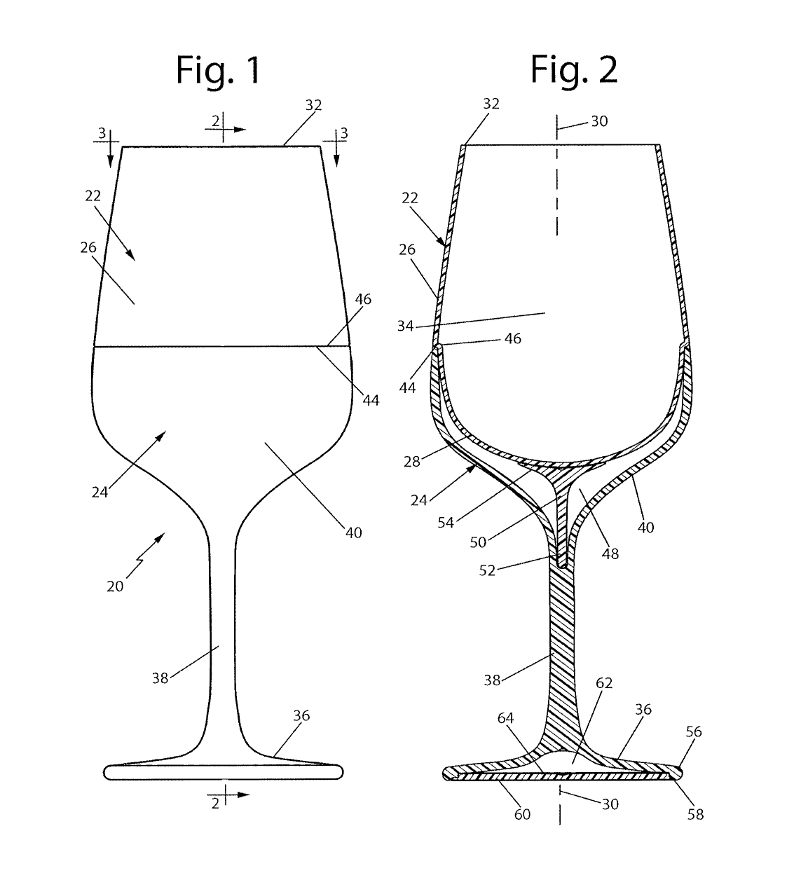

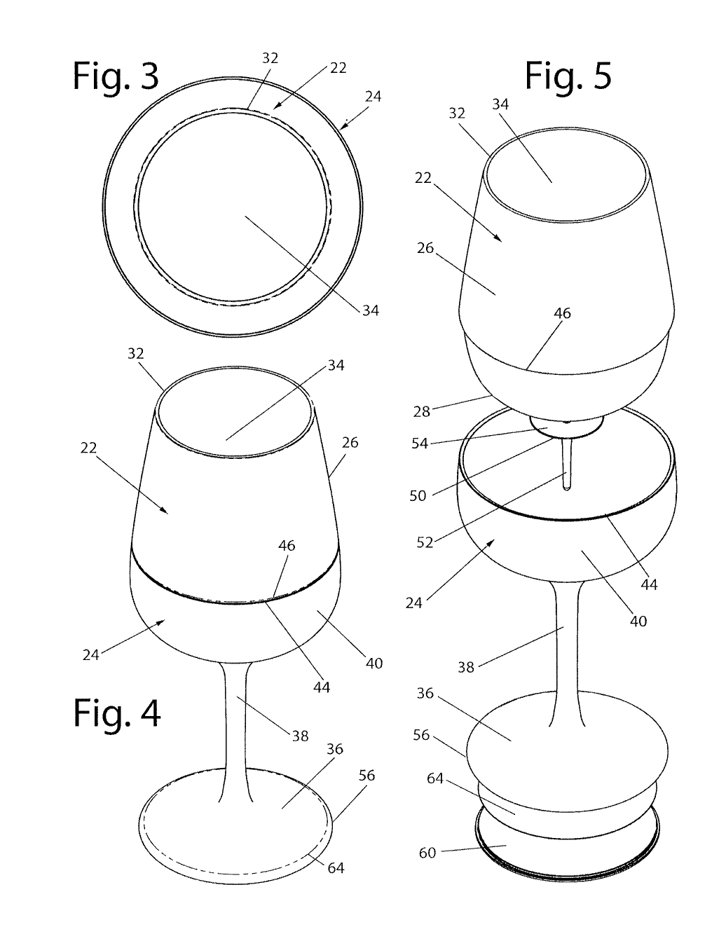

Referring now to the various figures of the drawing wherein like reference characters refer to like parts, there is shown at 20 in FIG. 1 one exemplary embodiment of a stemmed insulated drinking vessel, e.g., a wine glass, constructed in accordance with this invention. The wine glass 20 basically comprises a hollow bowl shaped member 22 and a base member 24. The bowl shaped member 22 has a side wall portion 26 and a bottom wall portion 28. The side wall portion 26 is an arcuate body of revolution extending about a central axis 30 (FIG. 2) of the wine glass 20. The arcuate side wall portion 26 terminates at a thin, e.g., 0.07 inch thick, drinking lip or rim 32. The bottom wall portion 28 is also arcuate and merges with the side wall portion 26 to form a bowl shaped member 22 having a continuous inner surface forming a hollow cavity 34 (FIG. 2) for receipt of a liquid, e.g., wine, to be held in the vessel. The bowl shaped member 22 is an integral unit that is formed, e.g., blow molded, of any suitable transparent plastic material, e.g., Eastman Tritan™ copolyester sold by Eastman Chemical Company. While it is preferred that the bowl shaped member be formed by blow molding, other molding techniques could be used, if desired and appropriate.

The base member 24 serves to support and hold the bowl shaped member 22 and comprises a base portion 36, a stem portion 38 and a holding portion 40. The support member 24 is an integral unit that is formed, e.g., injection molded, of any suitable transparent plastic material, e.g., also Eastman Tritan™ copolyester. While it is preferred that the bowl be formed by injection molding, other molding techniques could be used, if desired and appropriate. In any case, the base portion 36 is a hollow member which will be described in detail later and which serves to support the vessel 20 on whatever surface, e.g., a table, it is placed. The stem portion 38 of the base member 24 is an elongated member which extends upward from the base portion 26 and is centered on the central axis 30. The holding portion 40 of the base member extends upward from the stem portion 38 and comprises an arcuate side wall portion 42 which is also body of revolution extending about the central axis 30. The side wall portion 42 terminates at an upper edge 44 and is somewhat thicker than the side wall portion 26 of the bowl shaped member 22.

As best seen in FIGS. 2 and 5, the arcuate side wall portion 26 of the bowl shaped member 22 includes an undercut ledge 46 extending about the periphery of the arcuate side wall. The ledge 46 is located substantially below the thin upper rim 32 of the bowl shaped member.

The bowl shaped member 22 is disposed within the interior of the holding portion 40 with undercut ledge 46 disposed on and supported by the upper edge 44 of the holding portion 40. The bowl-shaped member is fixedly secured to the holding member by a seal line extending along the interface of the ledge 46 of the bowl shaped member 22 and the upper edge 44 of the holding member 40. In accordance with one preferred aspect of this invention that seal line is formed by ultrasonic welding. However other means for fixedly securing the bowl shaped member within the holding member are envisioned and may be used, if desired and appropriate.

In any case, with the bowl shaped member 22 fixedly secured within the holding portion 40 an insulating air space 48 is created between the two walls of those portions. This double walled insulating air space surrounds the bottom portion of the bowl shaped member, thereby helping to keep wine or any other liquid in the cavity 34 cool. Moreover, and quite significantly, since the double walled insulating air space is confined to the bottom portion of the bowl shaped member, persons drinking from the wine glass can do so comfortably at a thin upper lip or rim, i.e., lip 32.

In accordance with one preferred aspect of this invention the insulating stemmed drinking vessel 20 includes a dampening member 50 located within the insulating air space 48. The dampening member 50 serves to dampen any vibration imparted to the vessel when it is abruptly put down on some surface. Such action, particularly if repeated, could, absent the inclusion of the dampening member, result in some structural damage (e.g., cracks) in the plastic material(s) making up the vessel, particularly at or near the location of the weld seam. Thus, with the inclusion of the dampening member 50 any vibration imparted to the vessel during rough handling which would tend to cause the bowl shaped member (filled or unfilled with wine or other liquid) to resonate will be dampened and the vibratory energy directed from the bowl shaped member to the base.

In the exemplary embodiment shown the dampening member 50 is in the general shape of a golf tee having a stem section 52 and a flanged top section 54 extending above and outward of the stem section. The lower end of the stem section 52 is located within an elongated hollow portion of the air space 48 immediately above the stem portion 38 of the base member 24. The upper surface of the flanged top section 54 of the dampening member is of slightly concave shape to receive the outer surface of the bottom wall portion 28 of the bowl shaped member 22. Accordingly, the dampening member 50 is sandwiched between the bowl shaped member 22 and the stem portion 38 of the base member 24. The dampening member comprises any suitable material, e.g., ABS plastic, and can be formed using any suitable technique, e.g., injection molding.

In accordance with another preferred aspect of this invention the base portion 36 of the base 24 is hollow to include an internal decoration. In particular, as best seen in FIGS. 2 and 5 the base portion 36 is an outwardly flared member terminating in a thick peripheral edge portion 56. The bottom surface 58 of the peripheral edge portion 56 is planar. The peripheral edge portion 56 is undercut immediately adjacent the planar bottom surface 58 for receipt of a planar base disk 60. The base disk 60 is fixedly secured in the undercut portion of the base 24 by any suitable means. In the exemplary embodiment the securement is achieved by ultrasonic welding. However, other means could be used if desired and appropriate. The planar disk 60 can be formed e.g., molded, of any suitable plastic material, e.g., also Eastman Tritan™ copolyester.

The securement of the base disk 60 to the peripheral edge portion 56 of the vessel 20 produces a hollow space 62 within the base portion 24. As best seen in FIGS. 2 and 5 a thin, decorative disk 64 is disposed within the hollow space and on top of the top surface of the base disk 60. In the exemplary embodiment shown the decorative disk 64 is a thin film, e.g., 5 mil thick polyester, one side of which is printed with UV ink. Thus, when the decorative disk is in place in the hollow interior of the base member it will be visible through the transparent material making up the flanged base portion 36 to provide a decorative aesthetically pleasing appearance.

As best seen in FIG. 2, the bottom surface of the base disk 60 is flush with the bottom surface 58 of the peripheral edge portion 36 so that those flush surfaces serve as a single surface upon which the wine glass 20 is placed to support it on any support surface, e.g., a table (not shown). Thus, when the vessel 20 is placed on a table or any other support surface the bottom surface of the base disk 60 and the bottom surface of the peripheral edge portion 36 engage the table or other support surface to hold the vessel thereon in an upright orientation.

As mentioned above the method of producing the wine glass 20 (or any other stemmed insulated drinking vessel constructed in accordance with this invention) constitutes another aspect of this invention. To that end, the method entails providing a hollow bowl shaped member and a base member. The hollow bowl shaped member is molded, e.g., blow molded, of a plastic material, like that described above, to have a bottom wall and an arcuate side wall projecting upward from the bottom wall and terminating in a thin upper rim. The base member is molded, e.g., injection molded, of a plastic material, like that described above, to have a base portion, a stem portion and a holding portion, with the base portion having a flat undersurface, the stem portion being elongated and extending upward from the base portion and with the holding portion having an arcuate sidewall terminating in an upper edge. The bowl shaped member is disposed within the holding portion of the base member with the upper edge of the holding portion engaging a peripheral portion of the bowl shaped member below the upper rim along a seal line and is fixedly secured, e.g., laser welded, thereat to create an insulating air space between the bowl shaped member and the base member, whereupon a substantial portion of the vessel below the thin upper rim is double walled and insulated.

If desired a dampening member may be located between the bottom of the bowl shaped member and the portion of the base member adjacent the stem thereof before the bowl shaped member is placed within the holding portion of the base member and secured thereto. Moreover, if desired the dampening member may be formed so that it is decorative, e.g., it may be colored and/or have a textured surface to provide an aesthetically pleasing appearance.

If desired, the base portion of the base member may be formed to be hollow to accept a decorative member within its interior.

It should be pointed out at this juncture that the structure of the insulated stemmed drinking vessel and method or producing it as described above are merely exemplary of various structures and methods that are contemplated by this invention. Thus, for example, the insulated vessel 20 of this invention is not limited to use for holding wine. Rather, it can be used for holding other beverages. In fact, the beverages need not be cold, but may be hot. Moreover, side wall portions of the vessel 20 may be of other shapes and sizes than that shown in the drawing. For example, the vessel 20 could be in the shape of a champagne flute or any other shape of a stemmed drinking vessel, e.g., a goblet. What is important is that the side wall of the stemmed vessel includes a thin upper lip or rim formed by a single wall, while a substantial portion of the bowl of the vessel below the lip or rim is insulated via a double wall construction.

Without further elaboration the foregoing will so fully illustrate my invention that others may, by applying current or future knowledge, adopt the same for use under various conditions of service.

I claim:

1. An insulated stemmed drinking vessel comprising a hollow bowl shaped member and a base member, said hollow bowl shaped member being molded of a plastic material and having a bottom wall and an arcuate side wall projecting upward from said bottom wall and terminating in a thin upper rim, said bowl shaped member being adapted to hold a liquid therein, said base member being molded of a plastic material and comprising a base portion, a stem portion and a holding portion, said base portion having a flat undersurface, said stem portion being elongated and extending upward from said base portion, said holding portion comprising an arcuate sidewall terminating in an upper edge, said arcuate side wall of said bowl shaped member including an undercut ledge extending about the periphery of said arcuate side wall substantially below said thin upper rim, said bowl shaped member being disposed within said holding portion of said base member with said upper edge of said holding portion engaging said undercut ledge and being fixedly secured thereto along a seal line to create an insulating air space between said bowl shaped member and said support member, whereupon a substantial portion of said vessel below said thin upper rim is double walled and insulated.

2. The insulating stemmed drinking vessel of claim 1 additionally comprising a dampening member located within said insulating air space, said dampening member being arranged for dampening vibration imparted to said vessel.

3. The insulating stemmed drinking vessel of claim 2 wherein said dampening member comprises a stem section and a flanged top section extending above and outward of said stem section, said stem section of said dampening member engaging said stem portion of said holding member, said flanged top section of said dampening member engaging said bottom wall of said bowl shaped member.

4. The insulating stemmed drinking vessel of claim 2 wherein said dampening member is decorative.

5. The insulating stemmed drinking vessel of claim 1 wherein bowl shaped member and said base member are each transparent.

6. The insulating stemmed drinking vessel of claim 4 wherein bowl shaped member and said base member are each transparent and said dampening member is at least one of colored and having a textured surface, whereupon said dampening member provides an aesthetically pleasing appearance visible through said base member and said bowl shaped member.

7. The insulating stemmed drinking vessel of claim 1 wherein said base portion of said base member is hollow.

8. The insulated stemmed drinking vessel of claim 7 wherein a decorative member is disposed within said hollow base portion.

9. The insulated stemmed drinking vessel of claim 8 wherein said decorative member is a disk.

10. The insulated stemmed drinking vessel of claim 7 wherein said hollow base portion includes an outwardly flaring wall and a planar base disk fixedly secured thereto, said planar base disk forming said flat undersurface.

11. The insulated stemmed drinking vessel of claim 9 wherein said hollow base portion includes an outwardly flaring wall and a planar base disk fixedly secured thereto, said planar disk forming said flat undersurface, said decorative member being disposed over said planar disk.

12. A method of producing an insulated insulating stemmed drinking vessel comprising:
a) providing a hollow bowl shaped member molded of a plastic material and having a bottom wall and an arcuate side wall projecting upward from said bottom wall and terminating in a thin upper rim;
b) providing a base member molded of a plastic material and comprising a base portion, a stem portion and a holding portion, said base portion having a flat undersurface, said stem portion being elongated and extending upward from said base portion, said holding portion comprising an arcuate sidewall terminating in an upper edge;
c) disposing said bowl shaped member within said holding portion of said base member with said upper edge of said holding portion engaging a peripheral portion of said bowl shaped member below said upper rim along a seal line; and
d) fixedly securing said bowl shaped member to said base member along said seal line to create an insulating air space between said bowl shaped member and said base member, whereupon a substantial portion of said vessel below said thin upper rim is double walled and insulated.

13. The method of claim 12 wherein said fixedly securing said bowl shaped member to said support member is accomplished by welding.

14. The method of claim 13 wherein said welding is laser welding.

15. The method of claim 12 additionally comprising:
e) providing a dampening member within said insulating air space, said dampening member being arranged for dampening vibration imparted to said vessel.

16. The method of claim 15 wherein said bowl shaped member and said base member are each transparent and said dampening member comprises at least one of colored and having a textured surface, whereupon said dampening member is decorative and provides an aesthetically pleasing appearance visible through said base member and said bowl shaped member.

17. The method of claim 12 wherein said base portion of said base member is transparent and hollow, and wherein said method comprises providing a decorative member within said hollow base portion.

18. The method of claim 17 wherein said decorative item is a disk.

19. The method of claim 12 wherein said bowl shaped member is formed by blow molding.

20. The method of claim 12 wherein said base member is formed by injection molding.
